(19) United States
(12) Patent Application Publication
(10) Pub. No.: US 2010/0085146 A1
(43) Pub. Date: Apr. 8, 2010

(54) JSI residential and commercial access unit (RCA)

(75) Inventor: Linsley A. Johnson, Berkeley, CA (US)

Correspondence Address: Linsley A. Johnson, 2214 CHANNING WAY # 8, BERKELEY, CA, 94704, US

(73) Assignee: LINSLEY ANTHONY JOHNSON, BERKELEY, CA (US)

(21) Appl. No.: 12/584,039

(22) Filed: Aug. 31, 2009

Related U.S. Application Data
(60) Provisional application No. 61/191,042, filed on Sep. 8, 2008.

(51) Int. Cl. G06F 7/04

(52) U.S. Cl. 340/5.53

(57) ABSTRACT

The JSI Residential and Commercial Access Unit (RCA) is a biometric entry access unit designed for the residential and commercial markets and is an integral component in the JSI Key system integration that can reduce and eliminate identity and electronic theft and provide entry access to designated places.

JSI has developed a biometric based residential and commercial product to provide designated individual(s) access to high valued places. The JSI Residential and Commercial Access Unit can work in conjunction with the [JSI Key-application number 11-900-118] or the JSI Residential and Commercial Access unit (RCA) can be implemented as a stand alone product designed to provide the ultimate level of corporate and personal protection that can be deployed in multiple markets in a biometric based application.

The JSI Residential and Commercial Access (RCA) unit consists of a 5×12 digitized infrared biometric size adjustable scanner, a central processing unit with key board, display screen for residential application or a monitor for commercial applications, four outlet ports, biometric door knob and casing and up to (10) BISP—Biometric Identification Surface Pads are integrated and installed in the door area next to or above the door knob for instant access and the unit come in a cable and wireless application.

The (RCA) unit gives the owner the ability to enroll, confirm, and delete prints as needed for security reasons. This JSI (RCA) application is a major improvement and shift in technology moving from the dual locking systems of the mechanical bolt lock and single lock and chain to a biometric, electric and wireless locking systems.

In the residential application the JSI Residential and Commercial Access (RCA) unit can be deployed in hotels and resorts, condominiums, individual residence, residential state houses, and other short term or long term living facilities. The residential application is strategically designed for adults and children depending on the population of household prints can be adjusted in size over time.

When the JSI (RCA) application is installed access to the residence or designated facility can be granted with a JSI Key or by the prints enrolled in the (RCA) system.

In the commercial application the JSI Residential and Commercial Access (RCA) unit can be deployed in banks and financial institutions with vaults, commercial building, retail chains, small or large business that need to protect high valued or high risk areas for designated employees. In the commercial application the JSI (RCA) can be implemented on a scalable base depending on the business needs.

This scalability environment give the owner to space to enroll a higher number of prints or decrease the number of prints in the system. The JSI (RCA) can operate as a stand alone product and it can be integrated into a mainframe or security network.

In either application the JSI Residential and Commercial Access unit (RCA) can be professionally or personally installed in the source of protection by following the step by step instructions and thereby providing complete identification of all members with the date and time of their access to designated locations.

Manner and Process of Making

The JSI Residential and Commercial Application (RCA) is manufactured with the following components to result in the finish product. The (RCA) is physically shaped and molded from polyvinyl and fiber glass cast and the following items are installed.
1. (1) Windows based 5×12 CPU—central processing unit with a key board and a protective cover for the residential product.
2. Dimensions L×W×H (5×12×3) (2)lbs.
3. Biometric software with a digitize infrared biometric scanner embedded on top of the CPU with 500 dpi.
4. Enrollment Method: Single finger and multi-touch
5. Extraction Verification
6. Coaxial or CAT5 data cables or wireless application
7. Security Levels—Configurable—3 DES
8. BISP—Biometric Identification Surface Pads for entry access. 3.3×2.50/0.5 lbs/USB cable varies per house hold.
9. Biometric door knob and casing (Residential and Commercial)

Using the Same

The JSI Residential and Commercial Access (RCA) application can be implemented in two environments residential and commercial.

Residential:

The JSI Residential Access (RCA) application consist of a 5×12 central processing unit can be placed on desk top or mounted on a wall to provide a wireless or cord transmission source. After installing and powering the unit up according to instructions. The owner will be given a series of commands and questions to input a response numerically or biometrically.

Questions:

Who is the primary and secondary person(s) with control and access to this unit? (Type in data)

How many family members will have access to this unit?

(Type in data)

Are all the family members adults, if not please adjust scanner for adults and children?

How many points of entry and Biometric Identification Surface Pads (BIPS) are installed with this unit? (Type in data)

Commands:

Please enter the finger print or hand print or the primary and secondary person to have control and access to the unit and a brief profile. One of these prints must be active every time before authoring additional users to the system.

Please place the family member left or right index finger or his or her left or right thumb or complete hand print in designated area on the scanner to have the print scanned to the (RCA) unit. Please keep your finger or hand print on the scanner until the scan is completed and 100% scanned on the residential and commercial access unit (RCA).

After a print is scanned into the (RCA) unit a confirmation notice will appear on the (RCA) asking the owner to enter the name and data for that print. In the residential application up to 10 prints can be stored in the (RCA) unit to provide entry access to the residence. After all or the designated family members prints are installed into the (RCA) unit the prints will be downloaded to the (BISP) Biometric Identification Surface Pads installed in the residence to provide access at the designated entry points.

Prints can be downloaded to the (BISP) Biometric Identification Surface Pads on member by member bases or all at one time. Once all the prints are downloaded to the (BISP) then each (BISP) is connected electronically with cables or through the wireless application to the door(s) at the entry points with a connection back to (RCA) Residential and Commercial Access unit to identify the family member that is entering from any designated entry point.

At this point if a family member has a JSI Key they can have their prints transferred to access application (track 3) on the JSI Key. Therefore, they can enter the home with the JSI Key or their finger print or handprint. Once the process is complete any designated family member can enter the residence.

Commercial:

In the commercial structure the JSI Commercial Access (RCA) unit can be implemented on a scalable format based on the owners' need for space to enroll users in the (RCA) unit. The JSI Commercial Access (RCA) application consist of a 5×12 central processing unit with keyboard that is designed for (pc) desk top environment and can be enabled by wireless or cable transmission source. In the JSI Commercial application the (RCA) can be integrated back into a security mainframe for additional security monitoring.

The JSI (RCA) commercial application does a (1) print search and match against the assigned name code, biometric print series code and sub-group code enrolled in the database and then access will be granted, after an approve match has been identified in the database. The JSI (RCA) unit with the BISP—Biometric Identification Surface Pads can be implemented by administering the following procedures.

Each print enrolled in the JSI (RCA) commercial application is broken down by name codes, a series of prints by 50 and a sub-series1-9. JSI (RCA) unit comes with 24 preprogrammed names and the owner can select 10 names, then each name group hold 50 prints, and that group is broken down in a sub-group in integral of (10).

Depending on the number of prints enrolled in the (RCA) this security process increase the retrieval time by seconds.

### Coding Example

| | | | | | | | |
|---|---|---|---|---|---|---|---|
| Alpha | Beta | Gamma | Delta | Epsilon | Zeta | Eta | Theta |
| Iota | Kappa | Lambda | Mu | Nu | Xi | Omi- | Pi |
| | | | | | | cron | |
| Rho | Sigma | Tau | Upsilon | Phi | Chi | Psi | Omega |

Name Code: Alpha
Enrolled prints 1-50 (scalable integrals of 25)
Sub-group 1-10/11-20/21-30/31-40/41-50/
Alpha (enrolled print) + (sub-group number)

Once a print is scanned by a JSI Biometric Identification Surface Pad (BISP) the print is identified by the name code, print and sub-group number; this process is more efficient and faster compared to searching entire database that can have hundreds or thousands of prints. The owner has the option to program each (BISP) by name code if desired and only certain name codes prints will have access to designated areas with the facility.

Steps in the JSI-(RCA) Residential and Commercial enrollment process.
1. Select the designated control users of the (RCA) unit, these are individuals and their finger or hand prints that are required to initiate the (RCA) unit and enroll other users in the system. For the most accurate results, best practice and to eliminate false positives all user must use his or her left or right index finger, left or right thumb, or their entire hand.
2. The designated control users of the system must identify the users to be enrolled in the (RCA) system and enter their names and prints for enrollment in the (RCA) unit. The prints can only be entered by the registered control user(s) who has access and authority to enroll new users in the system.
3. The control users will verify the identity of the daily users of the system supported by their human resource department or designated person. The control user will make sure the users hands are clean and free of any visible or known variables.
4. The control user will activate the (RCA) system with their prints and enroll a new user by taking his or her left or right index finger, left or right thumb or their entire hand and place it on the JSI biometric scanner and scan the print into the system until. When the scan is complete a 100% indicator or approval command with given.
5. After all the prints and data are scanned into the JSI (RCA) Unit the access prints are transferred to each BISP—Biometric Surface Pad network to provide entry to the designated locations.
6. Finally the enrolled user can walk up to a BISP- and place their finger or hand on the (BISP) unit and it will give them access (open the door) to the designated secure location.
   BISP—Biometric Identification Surface Pad.

### CROSS-REFERENCE TO RELATED APPLICATIONS

1. JSI Key
Application number—11-900-118.

2. JSI Biometric Point of Sales Application
Application number—60-999-1117

3. JSI Biometric Automotive Application
Application number—61-191-041

4. JSI Biometric Residential and Commercial Access Unit
Application number 61-191-042 (RCA)

### STATEMENT REGARDING FEDERALLY SPONSORED RESEARCH OR DEVELOPMENT

No federally sponsored research is associated with this patent application.

### REFERENCE TO SEQUENCE LISTING, A TABLE OR COMPUTER PROGRAM LISTING COMPACT DISC APPENDIX

Not applicable for this product

### BACKGROUND OF THE INVENTION

The JSI Residential and Commercial Access (RCA) product and biometric application is integral part of the JSI biometric systems integration process and technology. The JSI Key along with the (CRS) Chip Recognition System (Patent Application #11-900-118) are the core components in controlling and integrating the automotive, point of sales, and residential and commercial access landscapes to a biometric based technology that can reduce and eliminate identity and electronic theft and provide entry access to high valued places or asset.

### BACKGROUND ON INVENTION

JSI has carefully analyzed the internal and external security environment from a commercial and residential aspect and a physical and personnel aspect and the JSI Residential and Commercial Access Unit (RCA) can control, reduce and eliminate any theft or access problems in the areas of securing high risk and high valued places or personal assets.

The JSI (RCA) unit provides biometric entry access for residential and commercial markets to control, restrict and authorize designated individual to have access to secure and high risk areas. This product and technology will reduce the enterprise sectors theft cost internally and externally.

### BRIEF SUMMARY OF THE INVENTION

The JSI Residential and Commercial Access (RCA) is the access component in the JSI Key system integration process. The (RCA) is designed for different types of residential and commercial markets. The JSI (RCA) provides biometric entry access to high values areas and assets.

### BRIEF DESCRIPTION OF THE SEVERAL VIEW OF THE DRAWING

From a desk top position The JSI Residential and Commercial Access Unit appears in the following dimensions L×W×H (5×12×3) (2)lbs. The (RCA) has (5×12) CPU—central processing unit with a key board and a protective cover for the residential product. It resembles your stand personal computers or the standard wall mounted home alarm system.

See FIG. (1) Cross Reference Application 11-900-118

See FIGS. (2, 3, and 4)

JSI Residential and Commercial Access System.

### DETAILED DESCRIPTION OF THE INVENTION

JSI has developed a biometric based residential and commercial product to provide designated individual(s) access to high valued places. The JSI Residential and Commercial Access Unit can work in conjunction with the JSI Key-application number 11-900-118 or the JSI Residential and Commercial Access unit (RCA) can be implemented as a stand alone product designed to provide the ultimate level of corporate and personal protection that can be deployed in multiple markets in a standard and secure application.

The JSI (RCA) unit consists of a 5×12 digitized infrared biometric size adjustable scanner, a central processing unit with key board, display screen for residential application or a monitor for commercial applications, four outlet ports, biometric door knob and casing and up to (10) BISP—Biometric Identification Surface Pads are integrated and installed in the door area next to or above the door knob for instant access and the unit come in a cable and wireless application.

The (RCA) unit gives the owner the ability to enroll, confirm, and delete prints as needed for security reasons. This JSI (RCA) application is a major improvement and shift in technology moving from the dual locking systems of the mechanical bolt lock and single lock to a biometric, electronic and wireless locking systems.

In the residential application the JSI (RCA) unit can be deployed in hotels and resorts, condominiums, individual residence, residential state houses, and other short term or long term living facilities. The residential application is strategically designed for adults and children depending on the population of household prints can be adjusted in size over time. When the JSI (RCA) application is installed access to the residence can be granted with the JSI Key for or by prints enrolled in the (RCA). Residential and Commercial Access System.

In the commercial application the JSI (RCA) unit can be deployed in banks and financial institutions with vaults, commercial building, retail chains, small or large business that need to protect high valued or high risk areas for designated employees. In the commercial application the JSI (RCA) can be implemented on scalable base depending on the business needs. This scalability gives the owner space to enroll a higher number of prints or decrease the number of prints in the system. The JSI Residential and Commercial Access Unit (RCA) can operate as a stand alone product and it can be integrated into a mainframe or security network.

In either application the JSI Residential and Commercial Access Unit (RCA) unit can be professionally or personally installed in the source of protection by following the step by step instructions and thereby providing complete identification of all members with the date and time of their access to designated locations.

Manner and Process of Making

The JSI Residential and Commercial Application (RCA) is made or manufactured with the following components to result in the finish product. The (RCA) is physically shaped and molded from polyvinyl and fiber glass cast and the following items are installed.
1. (1) Windows based 5×12 CPU—central processing unit with a key board with a protective cover.
2. Dimensions L×W×H (5×12×3) 2 lbs
3. Digitize infrared biometric size adjustable scanner embedded in the CPU with 500 dpi.
4. Enrollment Method: Single finger and multi-touch
5. Extraction Verification
6. Coaxial or CAT 5 data cables or wireless application
7. Security Levels—Configurable—3 DES
8. BISP—Biometric Identification Surface Pads for entry access. 3.3×2.50/0.5 lbs/USB cable varies per house hold.
9. Biometric door knob and casing (Residential and Commercial)

Using the Same

The JSI Residential and Commercial Access (RCA) application can be implemented in two environments residential and commercial.

Residential:

The JSI Residential Access (RCA) application consist of a 5×12 central processing unit can be placed on desk top or mounted on a wall to provide a wireless or cord transmission source. After installing and powering the unit up according to instructions. The owner will be given a series of commands and questions to input a response numerically or biometrically.

Questions:
(1) Who is the primary and secondary person with control and access to this unit? (Type in data)
(2) How many family members will be given access to this unit? (Type in data)
(3) Are all the family members adults, if not please adjust scanner for adults and children?
(4) How many points of entry and Biometric Identification Surface Pads (BIPS) are installed with this unit?
(Type in data)

Commands:

Please enter the finger print or hand print or the primary and secondary person to have control and access to the unit and a brief profile. One of these prints must be active every time before authoring additional users to the system.

Please place your left or right index finger, thumb or complete hand print in designated area on the scanner to have the print scanned to the (RCA) unit. Please keep your finger or hand print on the scanner until the scan is completed and illustrates 100% scanned on the residential access unit (RCA) unit.

After a print is scanned into the (RCA) unit a confirmation notice will appear on the (RCA) unit asking the owner to enter the requested name or data for that print. In the residential application up to 10 prints can be store in the (RCA) application to provide entry access to the residence.

After all or the designated family members prints are installed into the (RCA) unit the prints will be downloaded to designated number of (BISP) Biometric Identification Surface Pads installed in the residence to provide access the designated entry points.

Prints can be downloaded to the (BISP) Biometric Identification Surface Pads on member by member bases or all at one time. Once all the prints are downloaded to the (BISP) then each (BISP) is connected electronically with cables or through the wireless application to the door at the entry points with a connection back to (RCA) unit to identify the family member that is entering from any designated entry point.

At this point if a family member has a JSI Key they can have their prints transferred to access application (track 3) on the JSI Key. Therefore, they can enter the home with the JSI Key or their finger print or handprint. Once the process is complete any designated family member can enter the residence.

Commercial:

In the commercial structure the JSI Commercial Access (RCA) unit can be implemented on a scalable format based on the owners' need for space to enroll users in the (RCA) unit. The JSI Commercial Access (RCA) application consist of a 5×12 central processing unit with keyboard that is designed for (pc) desk top environment and can be enabled by enabled electronically with cables or by a wireless transmission source. In the JSI Commercial application the (RCA) can be integrated back into a security mainframe for additional security monitoring.

Depending on the potential or maximum number of users in the commercial application the enrollment base can be increased by selecting another name code from the 24 preprogrammed names that comes installed in the (RCA) unit. The JSI (RCA) commercial application does a (1) print search and match against the assigned name code, biometric print series code and sub-group code enrolled in the database and provides access after an match has been identified in the database. The JSI Residential and Commercial Access unit (RCA) with the BISP—Biometric Identification Surface Pads can be implemented by administering the following procedures.

Each print enrolled in the JSI (RCA) commercial application is broken down by name codes, a series of prints by 50, and a sub-series1-9. JSI (RCA) unit comes with 24 preprogrammed names and the owner can select 10 names, then each name group hold 50 prints, and that group is broken down in a sub-group in integral of (10). Depending on the number of prints enrolled in the (RCA) this security process increase the retrieval time by seconds.

### Coding Example

| | | | | | | | |
|---|---|---|---|---|---|---|---|
| Alpha | Beta | Gamma | Delta | Epsilon | Zeta | Eta | Theta |
| Iota | Kappa | Lambda | Mu | Nu | Xi | Omi- | Pi |
| | | | | | | cron | |
| Rho | Sigma | Tau | Upsilon | Phi | Chi | Psi | Omega |

Name Code: Alpha
Enrolled prints 1-50 (scalable integrals of 25)
Sub-group 1-10/11-20/21-30/31-40/41-50/
Alpha (enrolled print) + (sub-group number)

Alpha (enrolled print)+(sub-group number)

Once a print is scanned by a JSI Biometric Identification Surface Pad (BISP) the print is identified by the name code, print and sub-group number; this process is more efficient and faster compared to searching entire database that can have hundreds or thousands of prints. The owner has the option to program each (BISP) by name code if desired and only certain name codes prints will have access to designated areas with the facility.

Steps in the JSI-(RCA) Residential and Commercial enrollment process.
1. Select the designated control users of the (RCA) units, these are individuals and their finger or hand prints that are required to initiate the (RCA) unit and enroll other users in the system. For the most accurate results, best practice and to eliminate false positives all user must use his or her left or right index finger, left or right thumb, or their entire hand.
2. The designated control users of the system must identify the users to be enrolled in the (RCA) system and enter their names and prints for enrollment in the (RCA) unit. The prints can only be entered by the registered control user(s) who has access and authority to enroll new users in the system.
3. The control users will verify the identity of the daily users of the system supported by their human resource department or designated person. The control user will make sure the users hands are clean and free of any visible or known variables.
4. The control user will activate the (RCA) system with their prints and enroll a new user by taking his or her left or right index finger, left or right thumb or their entire hand and place it on the JSI biometric scanner and scan the print into the system until. When the scan is complete a 100% indicator or approval command with given.
5. After all the prints and data are scanned into the JSI (RCA) Unit the access prints are transferred to each BISP—Biometric Surface Pad network to provide entry to the designated locations.
6. Finally the enrolled user can walk up to BISP- and place their finger or hand on the (BISP) unit and it will give them access (open the door) to the designated secure location.

Drawing:

Formal Drawings for the JSI Residential and Commercial Access System.

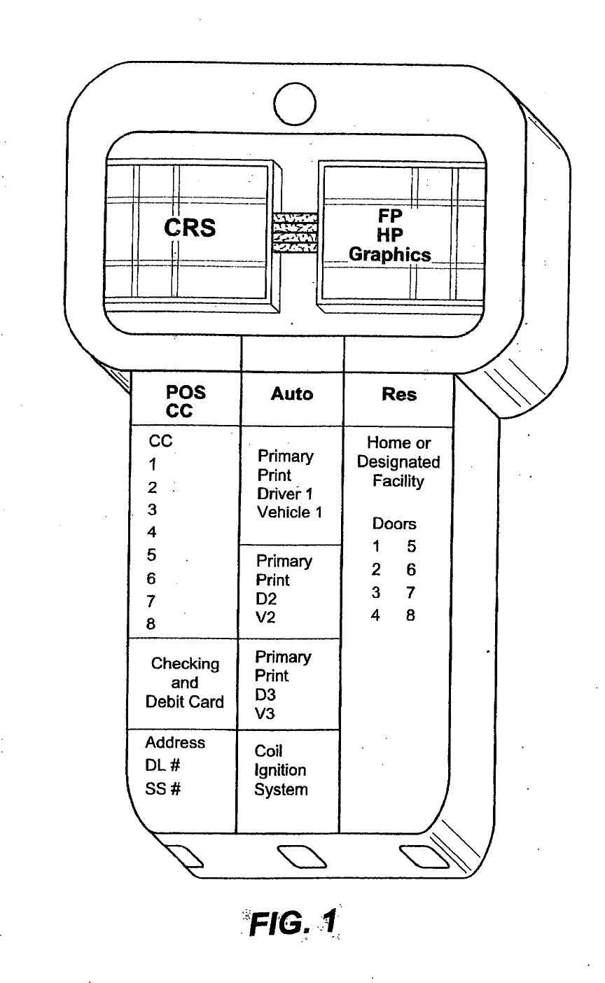

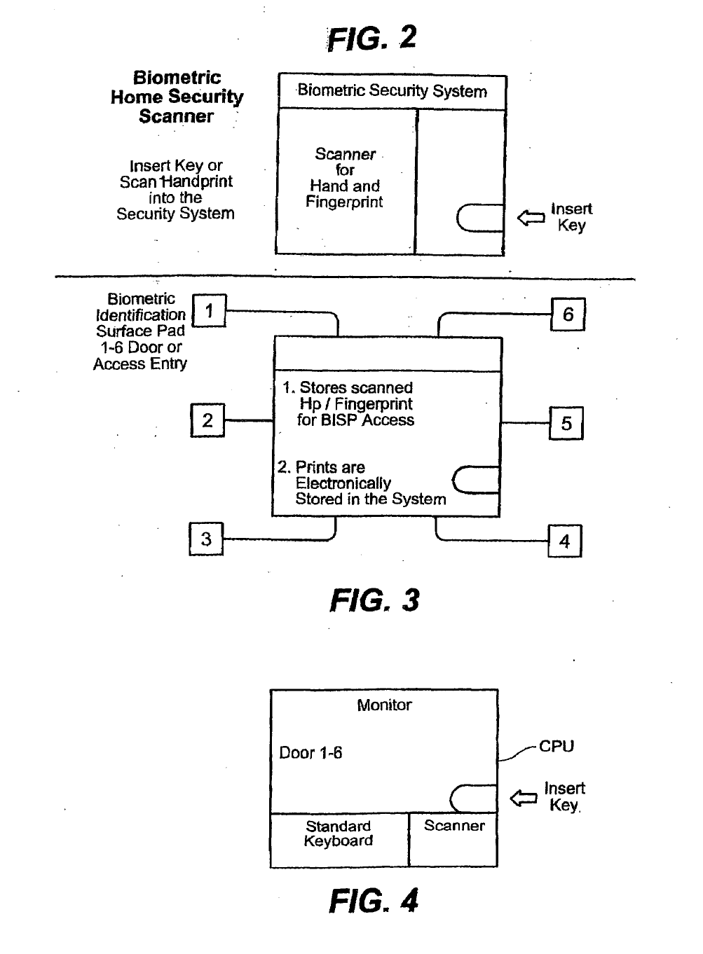

See FIGS. 1, 2, 3, and 4

JSI-BIOMETRIC ENTRY ACCESS KEY

| FIG. | |
|---|---|
| (1) | BIOMETRIC ENTRY ACCESS KEY |
| 10 | Biometric Key designed to prevent point of sales, vehicle |
| | thefts and provide entry access to high value assets or |
| | areas. Cross Reference Application 11-900-118 |
| 20 | Whole for carrying the biometric key on a key ring. |
| 30 | Chip Recognition System- System on a chip (CRS) |
| | designed to identify each landscape the biometric key can |
| | operate and provide access to; point of sales, automotive |
| | entry access. |
| 40 | Connectors that request, send and receive electrical signals |
| | to confirm and validate a stored finger print or hand print |
| | on a biometric chip or storage device. |
| 50 | Track (1) Point of sales: In this area the end user can store |
| | up to (8) credit or merchant card numbers, checking and |
| | debit card data, personal information, drivers' license, |
| | address. |
| 60 | Track (2) Vehicle/Auto: Provide up to (3) drivers secure |
| | biometric access to a vehicle to prevent theft. |
| 70 | USB connector to connect the biometric key to the |
| | designated landscape and provide the required data. |
| 80 | Track (3) Residential facility Access unit with up to |
| | (8) Biometric Identification Surface Pads. BISP. |
| 85 | Active light indicator to identify the key is properly |
| | working in each landscape; POS, AUTO, RESIDENTIAL. |
| 90 | Finger print/Hand Print chip for storing prints and |
| | verifying the designated owner. |

| FIGS. | |
|---|---|
| (2, 3, 4) | BIOMETRIC ENTRY ACCESS UNIT |
| 250 | Biometric security central processing unit |
| 260 | Monitor/Screen |
| 270 | Standard key board with number pad. |
| 280 | Biometric scanner for hand prints and finger print. |
| 290 | Insertion point for the biometric key. |
| 300 | Biometric Identification Surface Pad to provide biometric |
| | entry access at door entrance BISP (1) |
| 310 | Biometric Identification Surface Pad to provide biometric |
| | entry access at door entrance. BISP (2) |
| 320 | Biometric Identification Surface Pad to provide biometric |
| | entry access at door entrance. BISP (3) |
| 330 | Biometric Identification Surface Pad to provide biometric |
| | entry access at door entrance. BISP (4) |
| 340 | Biometric Identification Surface Pad to provide biometric |
| | entry access at door entrance. BISP (5) |
| 350 | Biometric Identification Surface Pad to provide biometric |
| | entry access at door entrance. BISP (6) |
| 360 | Biometric Identification Surface Pad to provide biometric |
| | entry access at door entrance. BISP (7) |
| 370 | Biometric Identification Surface Pad to provide biometric |
| | entry access at door entrance. BISP (8) |
| 380 | Serial port connectors for sending and verifying prints |
| | installed in the system to the biometric identification |
| | surface pads. BISP |

1. The JSI Residential and Commercial Access application (RCA) can provide biometric access to a designated residential entry points and access to high valued areas in the commercial sectors. The JSI (RCA) unit can enroll, read, scan and match finger and hand prints against the finger or hand prints stored in its database and provide access to designated places.
